(19) United States
(12) Patent Application Publication
(10) Pub. No.: US 2024/0088513 A1
(43) Pub. Date: Mar. 14, 2024

(54) Battery Pack

(71) Applicant: JIANGSU ZENERGY BATTERY TECHNOLOGIES CO., LTD., Jiangsu (CN)

(72) Inventors: Jiangnan DENG, Jiangsu (CN); Hao GUI, Jiangsu (CN); Junfeng DU, Jiangsu (CN); Quanliang JIN, Jiangsu (CN); Hongjiang YU, Jiangsu (CN)

(21) Appl. No.: 18/244,189

(22) Filed: Sep. 8, 2023

(30) Foreign Application Priority Data
Sep. 9, 2022 (CN) 202222408902.1
Sep. 9, 2022 (CN) 202222409024.5

(51) Int. Cl. H01M 50/342; H01M 10/613; H01M 10/647; H01M 10/6552; H01M 10/6554; H01M 50/209

(52) U.S. Cl. CPC H01M 50/3425; H01M 10/613; H01M 10/647; H01M 10/6552; H01M 10/6554; H01M 50/209

(57) ABSTRACT

The disclosure provides a battery pack. The battery pack includes a battery pack box body and a plurality of cells, wherein the battery pack box body has an accommodation space, the plurality of cells are stacked in the accommodation space, and each cell of the plurality of cells has a safety valve, a positive electrode terminal and a negative electrode terminal, the positive electrode terminal and the negative electrode terminal are located on a first surface of the cell, and the safety valve is located on a second surface of the cell; the battery pack box body further includes an accommodation pipeline and a cooling mechanism, wherein the accommodation pipeline and the cooling mechanism are both located in the accommodation space, the cooling mechanism is configured for supporting the second surface and cooling the cell, the accommodation pipeline is configured for accommodating molten substance collected by the accommodation holes.

### CROSS-REFERENCE TO RELATED DISCLOSURE

The present disclosure claims the priority of patent application no. 202222409024.5 and entitled “Cell, Battery Module, Battery Pack, Electric Device, and Apparatus for Preparing Cell”, and patent application no. 202222408902.1 and entitled “Battery pack box body, Battery Pack, Electric Device, and Apparatus for Manufacturing Battery Pack”, which were filed to the China National Intellectual Property Administration on Sep. 9, 2022.

### TECHNICAL FIELD

The present disclosure relates to the technical field of batteries, and in particular, to a battery pack.

### BACKGROUND

A positive electrode terminal and a negative electrode terminal of a traditional cell are arranged at an interval on one side of a housing, and an explosion-proof port is arranged at a position on the housing between the positive electrode terminal and the negative electrode terminal. With such an arrangement, when the explosion-proof port performs pressure relief, discharged molten substance easily affects the positive electrode terminal and the negative electrode terminal, thereby causing risks such as a short circuit. To this end, in the related art, the provision position of the explosion-proof port is kept away from the positive electrode terminal and the negative electrode terminal. However, a cell with such an arrangement still can not solve the problem of spreading to other adjacent cells during thermal runaway, and still has the problem of low safety performance.

### SUMMARY

An object of some embodiments of the present disclosure is to provide a battery pack capable of effectively preventing spreading of thermal runaway.

In order to achieve the described object, according to an embodiment of the present disclosure, provided is a battery pack, including: a battery pack box body and a plurality of cells, wherein the battery pack box body has an accommodation space, the plurality of cells are stacked in the accommodation space, and each cell of the plurality of cells has a safety valve, a positive electrode terminal and a negative electrode terminal, the positive electrode terminal and the negative electrode terminal are located on a first surface of the cell, and the safety valve is located on a second surface of the cell, the first surface and the second surface are a group of opposite surfaces of the cell; the battery pack box body further includes an accommodation pipeline and a cooling mechanism, wherein the accommodation pipeline and the cooling mechanism are both located in the accommodation space, and the second surface is arranged to face the accommodation pipeline and the cooling mechanism, the cooling mechanism is configured for supporting the second surface and cooling the cell, accommodation holes of the accommodation pipeline are arranged corresponding to the safety valves, and the accommodation pipeline is configured for accommodating molten substance collected by the accommodation holes.

In an embodiment, the accommodation pipeline is provided with a plurality of accommodation holes of which the number matches the number of the plurality of cells, and a plurality of safety valves are arranged in one-to-one correspondence with the plurality of accommodation holes.

In an embodiment, each of the safety valves is able to extend into a corresponding accommodation hole of the plurality of accommodation holes.

In an embodiment, the safety valve is recessed in the second surface of the cell, the safety valve and the accommodation hole are opposite to each other and are arranged at an interval, and the circumference of the second surface is supported on the accommodation pipeline and closes a corresponding accommodation hole of the plurality of accommodation holes.

In an embodiment, the cooling mechanism at least includes two cooling pipelines located at two sides of the accommodation pipeline, a mounting groove is formed between the two cooling pipelines, and the accommodation pipeline is mounted in the mounting groove.

In an embodiment, the battery pack box body includes a plurality of accommodation pipelines arranged at intervals, the cooling mechanism includes a plurality of cooling pipelines arranged at intervals, and the plurality of cooling pipelines and the plurality of accommodation pipelines are alternately arranged in sequence.

In an embodiment, the battery pack box body further includes a bottom plate, the accommodation pipeline and cooling pipelines of the cooling mechanism are both arranged on the bottom plate, and the second surface of the cell is arranged to face the bottom plate, the accommodation pipeline includes an accommodation plate arranged in a bent manner; the accommodation holes are provided on the accommodation plate, the accommodation plate has a bottom opening, the accommodation plate is arranged on the bottom plate, the bottom opening is closed by the bottom plate, and the accommodation plate and the bottom plate together enclose a channel for accommodating molten substance.

In an embodiment, the bottom plate has a bottom plate groove recessed in a direction away from the accommodation holes, the bottom plate groove is configured for accommodation an adhesive, and an end edge of the accommodation plate provided with the opening extends into the bottom plate groove so as to be connected to the adhesive.

In an embodiment, the accommodation pipeline is welded to the bottom plate.

In an embodiment, the accommodation pipeline and the bottom plate are integrally formed.

In an embodiment, the safety valve is provided at the middle position of the second surface.

In an embodiment, the battery pack further includes a protective plate, the protective plate includes a first weak portion, and the first weak portion is arranged corresponding to the safety valve, so that the first weak portion is cracked under the impact of the molten substance discharged from the safety valve.

In an embodiment, the cell is provided with an explosion-proof port, the safety valve is provided at the explosion-proof port, and the safety valve includes: an explosion-proof sheet, the explosion-proof sheet being recessed into an inner side of the cell in a direction opposite to a pressure relief direction; and a protective sheet, the protective sheet being spaced apart from the explosion-proof sheet to form a cavity therebetween, and the protective sheet covering an outer side of the explosion-proof sheet.

In an embodiment, the protective sheet is provided with one or more discharge holes, and the discharge holes are configured for discharging the molten substance discharged from the explosion-proof sheet.

In an embodiment, the protective sheet is provided with a second weak portion, and the second weak portion is configured for cracking under the impact of the molten substance discharged from the explosion-proof sheet for pressure relief.

In an embodiment, the explosion-proof sheet is provided with a groove, and an opening of the groove faces towards the protective sheet.

In an embodiment, a perpendicular distance from a groove opening of the groove to the bottom of the groove is the depth of the groove, and the depth of the groove is smaller than the thickness of the explosion-proof sheet in the pressure relief direction.

In an embodiment, the safety valve further includes an auxiliary cracking member, the auxiliary cracking member includes a sharp portion provided on the protective sheet, the sharp portion is located at the side of the protective sheet close to the explosion-proof sheet, and when the explosion-proof sheet moves towards the protective sheet under an impact force of thermal runaway of the cell, the sharp portion is configured to puncture the explosion-proof sheet.

In an embodiment, an outer surface of the protective sheet is flush with the second surface.

In an embodiment, the plurality of cells form a battery module, the battery module further includes two end plates, and the plurality of cells are stacked between the two end plates in a preset direction.

In an embodiment, the battery pack box body further includes a side frame and a bottom plate, the side frame is provided with a supporting step, the battery module is supported on the supporting step, and the bottom of the battery module is spaced apart from the bottom plate and a chamber is formed therebetween.

In an embodiment, a discharge port is provided on the side frame and/or the bottom plate, and the discharge port is in communication with the chamber.

The cooling mechanisms provided in some embodiments of the present disclosure may perform a cooling operation on the cells, so as to reduce the risk of thermal runaway of the cells; and the accommodation pipeline is provided with accommodation holes at positions facing upward, so that the molten substance ejected during thermal runaway of a cell moves downward under the action of gravity and is accommodated by the accommodation holes, thereby reducing splashing of the molten substance, and reducing the effect on other cells, so as to improve safety performance. On the other hand, the cooling mechanisms and the accommodation pipeline are both arranged on the bottom plate, so that the mounting space of the bottom plate of the case body is fully utilized, and the space utilization of the battery pack is improved, thereby making the structure of the battery pack more compact and reliable.

### BRIEF DESCRIPTION OF THE DRAWINGS

The drawings of the description, constituting a part of the present disclosure, are used for providing further understanding of some embodiments of the present disclosure, and the illustrative embodiments of the present disclosure and illustrations thereof are used to explain some embodiments of the present disclosure, rather than constitute inappropriate limitation on some embodiments of the present disclosure. In the drawings:

FIG. 1 is a schematic structural diagram of a battery pack provided according to embodiments of the present disclosure;

FIG. 2 is a schematic exploded diagram of a battery pack provided according to embodiments of the present disclosure;

FIG. 3 is a local schematic diagram of a partial structure of a battery pack provided according to embodiments of the present disclosure;

FIG. 4 is a schematic structural diagram of a battery module provided according to embodiments of the present disclosure;

FIG. 5 is a local schematic diagram of a partial structure of a battery module provided according to embodiments of the present disclosure;

FIG. 6 is a schematic structural diagram I of a housing of a cell provided according to embodiments of the present disclosure;

FIG. 7 is a schematic cross-sectional diagram I of a housing of a cell provided according to embodiments of the present disclosure;

FIG. 8 is a partially enlarged diagram of I of FIG. 7;

FIG. 9 is a schematic state diagram when an explosion-proof sheet of a cell is subjected to an impact force provided according to embodiments of the present disclosure;

FIG. 10 is a schematic structural diagram II of a housing of a cell provided according to embodiments of the present disclosure;

FIG. 11 is a schematic cross-sectional diagram II of a housing of a cell provided according to embodiments of the present disclosure;

FIG. 12 is a partially enlarged diagram of II of FIG. 11;

FIG. 13 is a schematic structural diagram of a protective sheet of a cell provided according to embodiments of the present disclosure;

FIG. 14 is a local schematic diagram of a partial structure of a battery pack provided according to embodiments of the present disclosure;

FIG. 15 is a local schematic cross-sectional diagram I of a partial structure of a battery pack provided according to embodiments of the present disclosure;

FIG. 16 is a schematic structural diagram of a battery pack box body provided according to embodiments of the present disclosure;

FIG. 17 is a schematic structural diagram of an exhaust plate of a battery pack box body provided according to embodiments of the present disclosure; and

FIG. 18 is a schematic cross-sectional diagram II of a partial structure of a battery pack provided according to embodiments of the present disclosure.

### REFERENCE SIGNS

100. Cell; 101. Housing; 2031. Winding core; 103. Positive electrode terminal; 105. Negative electrode terminal; 107. Explosion-proof port; 1071. Accommodation space; 109. Safety valve; 111. Explosion-proof sheet; 113. Groove; 115. Groove bottom; 116. Groove wall; 117. Groove opening; 119. Protective sheet; 121. Mounting annular groove; 123. Discharge hole; 125. Sharp portion; 127. Cavity; 200. Battery module; 201. Outer housing; 202. End plate; 203. Side plate; 205. Protective plate; 207. First weak portion; 300. Battery pack; 301. Battery pack box body; 303. Side frame; 305. Bottom plate; 307. Side beam; 309. Supporting step; 311. Chamber; 1071. Accommodation space 1071; 1091. Accommodation pipeline; 1111. Accommodation hole; 1131. Cooling pipeline; 1151. Cooling cavity; 1171. Mounting groove; 1191. First connector; 1211. Bottom opening; 1221. Accommodation plate; 1231. First plate; 1251. Second plate; 1271. Third plate; 129. Fourth plate; 131. Fifth plate; 133. Bottom plate groove.

### DETAILED DESCRIPTION OF THE EMBODIMENTS

It is to be noted that embodiments in the present disclosure and features in the embodiments is combined with one another without conflicts. Hereinafter, the present disclosure is described in detail with reference to the accompanying drawings and in conjunction with the embodiments.

A positive electrode terminal and a negative electrode terminal of a traditional cell are arranged at an interval on the same side of a housing, and an explosion-proof port is arranged at a position on the housing between the positive electrode terminal and the negative electrode terminal. With such an arrangement, when the explosion-proof port performs pressure relief, discharged molten substance easily affects the positive electrode terminal and the negative electrode terminal, thereby causing risks such as a short circuit. To this end, in the related art, the provision position of the explosion-proof port is kept away from the positive electrode terminal and the negative electrode terminal. However, a cell with such an arrangement still can not solve the problem of spreading to other adjacent cells during thermal runaway, and still has the problem of low safety performance.

Therefore, the present embodiment provides a cell; by configuring a safety valve as a unidirectional explosion-proof structure, the safety valve only is opened when thermal runaway occurs in a corresponding cell, and closed when thermal runaway occurs in adjacent cells or other cells, thereby effectively preventing spreading of thermal runaway, and improving the safety performance. Hereinafter, structures of the cell, a battery module including the cell, and a battery pack including the battery module are introduced in detail.

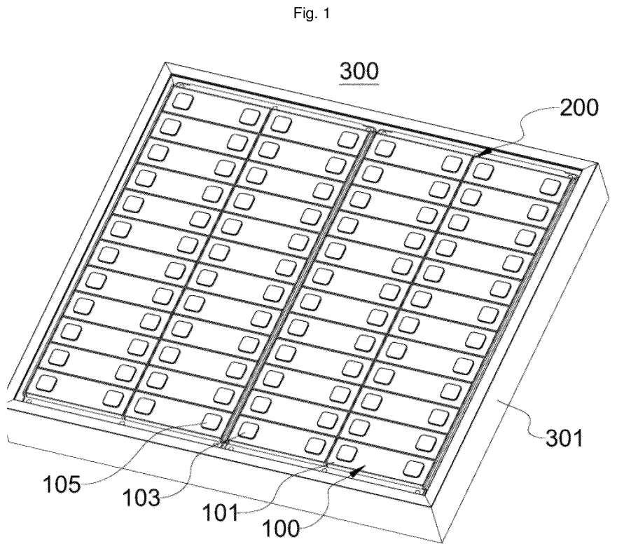

Please refer to FIGS. 1 to 4, the present embodiment provides a battery pack 300, which includes a battery pack box body 301 and a plurality of battery modules 200. Specifically, the battery pack box body 301 is a frame of the battery pack 300, and is configured to protect the safety of the battery modules 200, so as to ensure that the battery modules 200 is able to normally perform charge and discharge operations. The battery pack box body 301 includes a side frame 303 and a bottom plate 305, wherein the side frame 303 is a rectangular frame structure enclosed by four side beams 307 and forms an accommodation space 1071, and the bottom plate 305 is arranged at an end portion of the rectangular frame structure, so that the whole battery pack box body 301 is in a semi-open shape. The plurality of battery modules 200 are arranged inside the rectangular frame structure, and the circumferences of the battery modules 200 are surrounded by the side frames 303, so as to ensure the safety of the battery modules 200. Of course, in other embodiments, the number of side frames 303 and the shape of the battery pack box body 301 is adjusted according to requirements; in addition, a cooling mechanism is provided between the bottom plate 305 and the bottoms of the battery modules 200, so as to improve the heat dissipation effect of the battery modules 200.

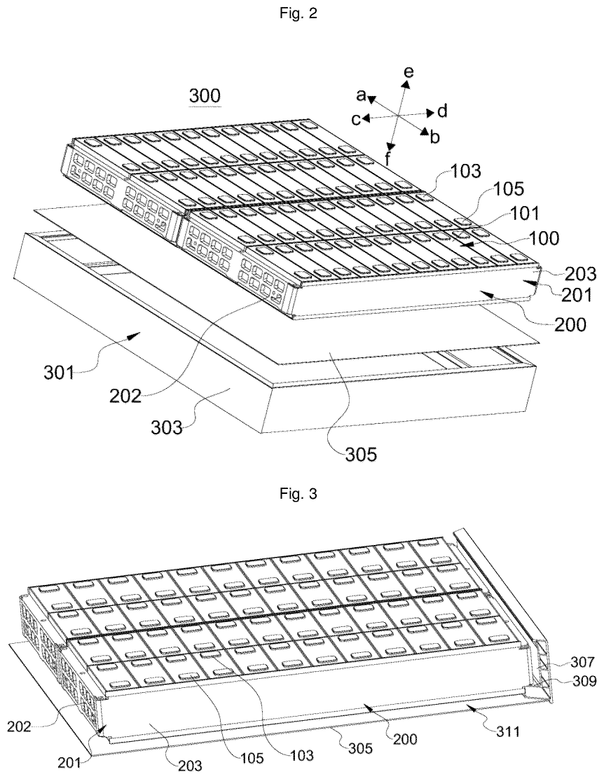

In the present embodiment, the number of the battery modules 200 is two, and the two battery modules 200 are arranged in parallel in the battery pack box body 301 in a first direction (i.e. the ab direction in FIG. 2). Moreover, each battery module 200 includes two groups of cell assemblies arranged in parallel along the first direction; each group of cell assemblies include a plurality of cells 100 stacked along a second direction (i.e. the cd direction in FIG. 2); wherein the height direction of each cell of the plurality of cells 100 is the ef direction in FIG. 2, the length direction of the cell 100 is the first direction, and the thickness direction of the cell 100 is the second direction, that is, the ab, cd and ef directions are perpendicular to each other. The height direction of each cell of the plurality of cells 100 is the third direction (the first direction, the second direction, and the third direction being perpendicular to each other). By such an arrangement, the battery pack box body 301 is able to accommodate more cells 100 in a volume range, which is able to ensure the energy density of the battery pack 300. Certainly, in other embodiments, the number of battery modules 200 included in the battery pack 300, the number of cell assemblies included in each battery module 200, and the number of cells 100 included in each cell of the plurality of cells assembly may all be adjusted according to requirements; in addition, the cells 100 are directly connected in series or in parallel to form the battery pack 300. It should be noted that, in the present embodiment, a preset direction refers to the second direction, and certainly, in other embodiments, the preset direction is a direction other than the second direction.

In the present embodiment, each battery module 200 includes an outer housing 201, and the number of the outer housings 201 matches the number of the cell assemblies, so that a plurality of cells 100 of each cell assembly are stacked in a corresponding outer housing 201. Moreover, the outer housing 201 includes two end plates 202 and two side plates 203, wherein the two end plates 202 are provided at two ends of the stacking direction of a plurality of cells 100 of a corresponding cell assembly, and the two side plates 203 are arranged at an interval between the two end plates 202. The two end plates 202 and the two side plates 203 enclose a rectangular cylindrical structure, which is able to ensure the safety and stability of the circumference of the cell assembly. Certainly, in other embodiments, the outer housing 201 of the battery module 200 may further only include two end plates 202, and in this case, the plurality of cells 100 are tightly fastened by cable ties.

It should be noted that, please refer to FIG. 3 again, in the present embodiment, the side beams 307, at positions corresponding to the side plates 203 of the battery module 200, of the battery pack box body 301 of the battery pack 300 are both substantially L-shaped hollow structures, and supporting steps 309 are formed on parallel parts of the L-shaped structures; and end plates 202 of a housing 101 of the battery module 200 are supported on the supporting steps 309, and after the battery module 200 is supported on the supporting steps 309, a chamber 311 is formed between the bottom of the battery module 200 and the bottom plate 305 of the battery pack 300. The arrangement of the supporting steps 309 facilitates ensuring the stability and reliability of the battery module 200, and may ensure the efficiency and quality of charge and discharge operations, and the existence of the chamber 311 facilitates heat dissipation of the battery module 200. Certainly, in other embodiments, each side beam 307 of the side frame 303 of the battery pack box body 301 also is set as an L-shaped hollow structure, so that each side beam 307 forms a supporting step 309, and thus the end plates 202 and the side plates 203 of the battery module 200 all are arranged on the supporting steps 309 at corresponding positions, thereby further improving the stability and safety of the battery module 200.

In addition, it should be noted that each battery module 200 is further provided with a CCS assembly, and the CCS assembly includes a wire harness isolation plate, FPC members, and connecting bars; wherein the wire harness isolation plate is supported on the outer housing 201 or is supported at ends of the cells 100, the connecting bars are configured for connecting the cells 100 in series or in parallel, each cell of the plurality of cells assembly is correspondingly provided with one FPC member, and the FPC member is electrically connected to a plurality of connecting bars of each cell of the plurality of cells assembly and is supported on the wire harness isolation plate. The CCS assembly collects parameters such as temperature and pressure of the cells 100, to ensure normal charge and discharge operations of the battery pack 300. Certainly, in other embodiments, middle module structures are omitted, and the plurality of cells 100 are directly stacked in the battery pack box body to form the battery pack.

In some embodiments of the present disclosure, each cell of the plurality of cells 100 includes a housing 101, a winding core 2031 and a safety valve 109. The housing 101 is of a rectangular structure, and the housing 101 is provided with a positive electrode terminal 103 and a negative electrode terminal 105. The winding core is provided in the housing 101, and the winding core is formed by winding or laminating a positive electrode sheet, a negative electrode sheet and a separator; a positive electrode tab is welded on the positive electrode sheet, a negative electrode tab is welded on the negative electrode sheet, the positive electrode tab is electrically connected to the positive electrode terminal 103, and the negative electrode tab is electrically connected to the negative electrode terminal 105, so as to ensure that the cell 100 may perform normal charge and discharge operations. Definitely, the housing 101 is further internally provided with an electrolyte, so as to ensure normal charge and discharge. In addition, in the present embodiment, an explosion-proof port 107 is further provided on an end face of the housing 101; and in order to separate the electrode terminals of the cell 100 from the explosion-proof port 107, to reduce the effect on the electrode terminals of the cell 100 when the explosion-proof port 107 is subjected to pressure relief so as to achieve thermoelectric separation, in the present embodiment, the positive electrode terminal 103 and the negative electrode terminal 105 of the housing 101 are both provided at one end of the height direction of the cell 100, and the explosion-proof port 107 is provided at the other end of the height direction of the cell 100. Such an arrangement may sufficiently reduce the effect of the explosion-proof port 107 on the electrode terminals, and may effectively reduce or prevent the occurrence of short circuit of the electrode terminals caused by molten substances ejected from the explosion-proof port 107.

Certainly, in other embodiments, the positive electrode terminal 103 and the negative electrode terminal 105 are not necessarily arranged on the same side, the positive electrode terminal 103 and the negative electrode terminal 105 is separately arranged on two sides in the width direction of the cell 100, and it is also possible that the explosion-proof port 107 is provided on one side in the length direction, and it is ensured that the explosion-proof port 107 is provided on the side, where the positive electrode terminal 103 and the negative electrode terminal 105 are not arranged, in the circumferential direction of the housing 101.

Taking the direction as shown in FIG. 6 as a reference, the positive electrode terminal 103 and the negative electrode terminal 105 are located on a top surface of the cell 100, the top surface being defined as a first surface; and the safety valve 109 is located on a bottom surface of the cell 100, the bottom surface being defined as a second surface.

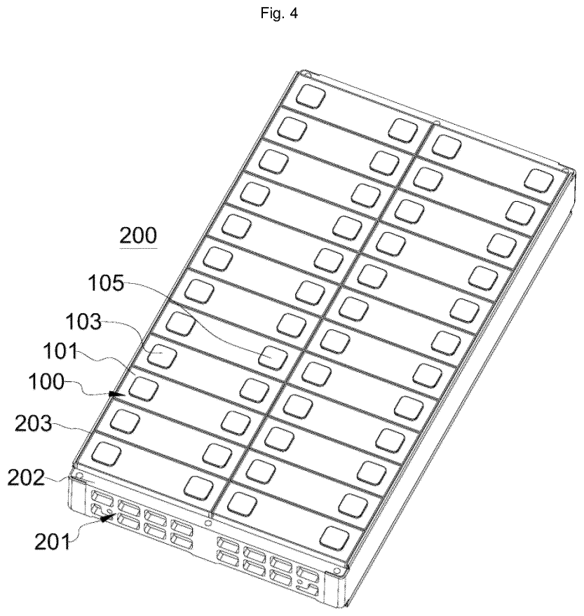

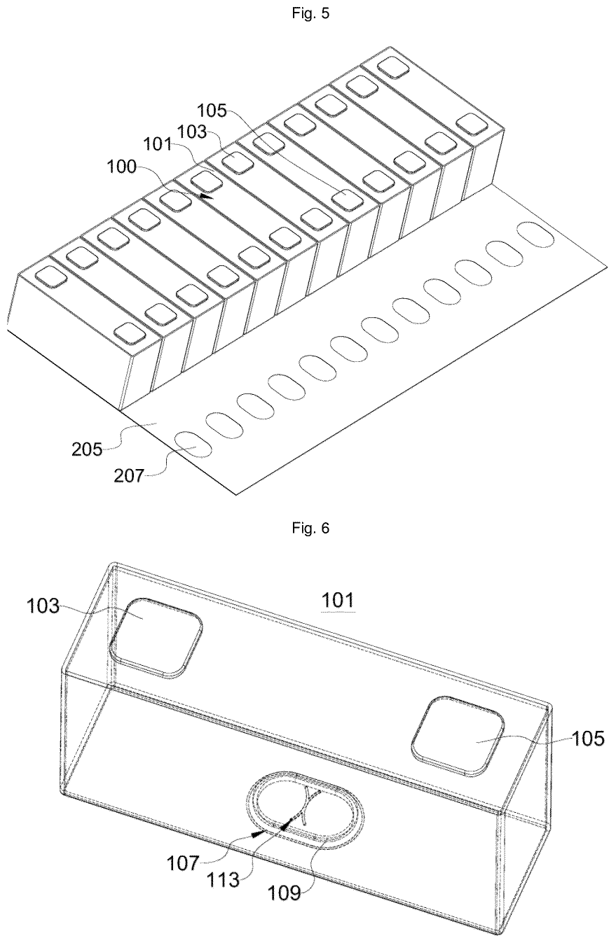

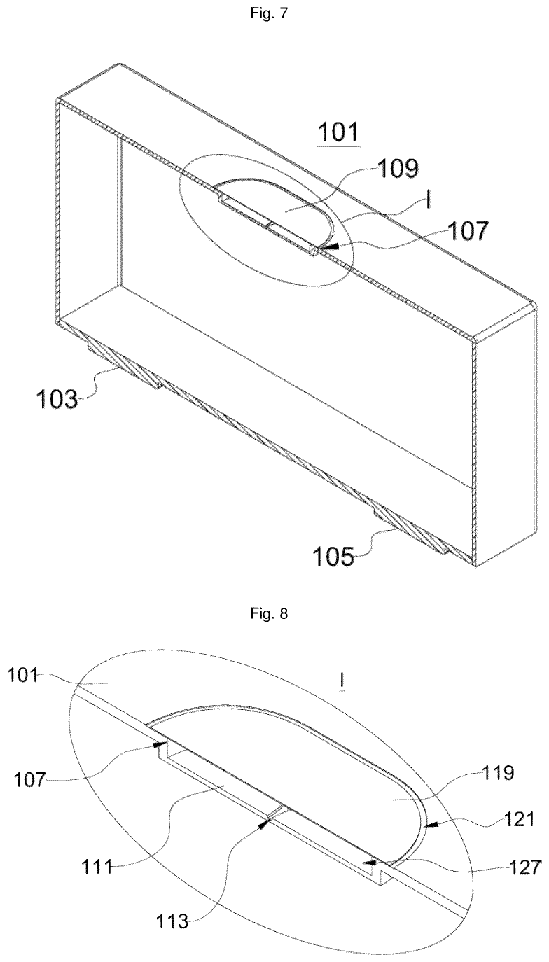

Please refer to FIGS. 6 and 7 again, in the present embodiment, the safety valve 109 is arranged at the explosion-proof port 107, and as the safety valve 109 is located at the bottom of the cell 100 in the height direction, a pressure relief direction of the safety valve 109 is understood as the ef direction in FIG. 2 (since the pressure relief direction is not necessarily fixed, ef only represents a general flow direction of molten substance during pressure relief, and does not mean that the pressure relief direction can not deviate relative to the ef direction), and an opposite direction of the pressure relief direction is an fe direction. As can be determined from FIG. 6, the safety valve 109 is arranged at the middle position of the second surface.

Specifically, the safety valve 109 includes an explosion-proof sheet 111, wherein the explosion-proof sheet 111 is in a sheet-like structure and matches the shape of the explosion-proof port 107, so as to well block the explosion-proof port 107, thereby ensuring safety of the cell 100 during normal working. In the present embodiment, the explosion-proof sheet 111 is provided with a groove 113. The groove 113 is a rectangular strip-shaped groove, the groove 113 has a groove bottom 115 and two groove walls 116 oppositely arranged at two sides of the groove bottom 115, the end of the two groove walls 116 away from the groove bottom 115 forms a groove opening 117 opposite to the groove bottom 115; and in the pressure relief direction, the groove bottom 115 and the groove opening 117 are arranged at an interval, so that the groove bottom 115 is arranged closer to the electrode terminals relative to the groove opening 117.

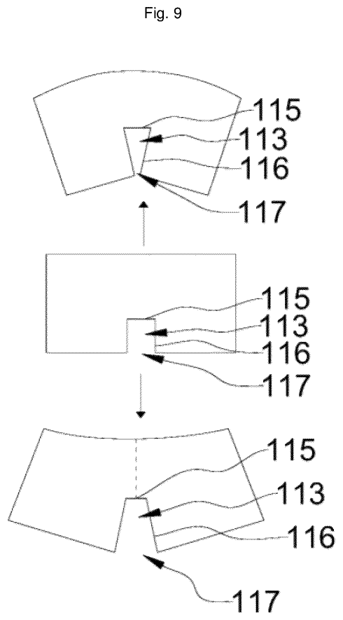

As shown in FIG. 9, by such an arrangement, when the explosion-proof sheet 111 is subjected to an impact force in the pressure relief direction, the two opposite groove walls 116 move away from each other, and at this time, the position of the groove bottom 115 becomes a weak portion, so that the position where the explosion-proof sheet 111 is in contact with the groove bottom 115 is easily broken under the action of the impact force. That is, when thermal runaway occurs in the cell 100, due to the arrangement of the groove 113, the explosion-proof sheet 111 is more likely to crack under an impact force of the thermal runaway, so as to perform a pressure relief operation. By the same reasoning, when the explosion-proof sheet 111 is subjected to an impact force in a direction opposite to the pressure relief direction, since the groove opening 117 of the groove 113 is located upstream of the impact force, the groove opening is subjected to the impact force first, so that the two opposite groove walls 116 move close to each other and abut against each other, thereby being able to prevent the explosion-proof sheet 111 from breaking. That is, when thermal runaway does not occur in the cell 100, if thermal runaway occurs in adjacent or other cells 100, an impact force is not easily transmitted to the explosion-proof sheet 111, and the explosion-proof sheet 111 is not easily to crack, thereby achieving the object of unidirectional explosion-proof, being able to effectively prevent the thermal runaway from spreading, and improving the safety performance of the battery module 200 and the battery pack 300.

It should be noted that, in the present embodiment, the perpendicular distance from the groove opening 117 to the groove bottom 115 of the groove 113 is the depth of the groove 113, and the depth of the groove 113 is smaller than the thickness of the explosion-proof sheet 111 in the pressure relief direction. By reasonably setting the depth of the groove 113, not only normal operation of the cell 100 is ensured, but also it can be ensured that the explosion-proof sheet 111 may perform a pressure relief operation during thermal runaway.

As an optional solution, in the present embodiment, the number of the groove 113 is one or more. In addition, the shape of the groove 113 is linear or arc-shaped. And when there are a plurality of grooves 113, at least two grooves 113 intersect or are tangent to each other. Two intersecting or tangent grooves 113 may allow for an intersection point between the grooves 113, the intersection point may direct molten substances due to breaking of the explosion-proof sheet 111 to flow in a centralized manner towards the intersection point, and the occurrence of splashing problem is reduced, thereby further reducing the effect on other cells 100, and further improving the safety of the battery module 200 and the battery pack 300.

Specifically, please refer to FIG. 6 again, in the present embodiment, the number of the grooves 113 is two, the two grooves 113 both extend in an arc shape, and the two grooves 113 are tangent to each other and substantially form an “X”-shaped structure. With such an arrangement, molten substance due to breaking of the explosion-proof sheet 111 is directed to flow in a centralized manner towards the intersection point, and the occurrence of splashing problem is reduced. Certainly, in other embodiments, the shape of the grooves 113 is linear, and the number of the grooves 113 also is adjusted according to requirements.

In the present embodiment, the safety valve 109 further includes a protective sheet 119 covering the exterior of the explosion-proof sheet 111; the protective sheet 119 is located at the side of the explosion-proof sheet 111 away from the electrode terminals, and the protective sheet 119 is in a disc shape; a mounting annular groove 121 is provided at the explosion-proof port 107, and the protective sheet 119 is accommodated in the mounting annular groove 121. In the present embodiment, the protective sheet 119 is configured to provide protection and blocking functions. Moreover, in order to ensure that the explosion-proof sheet 111 may perform normal pressure relief operation after cracking, one or more discharge holes 123 is provided at positions of the protective sheet 119 opposite to the explosion-proof sheet 111, and the discharge holes 123 are configured to discharge molten substance discharged from the explosion-proof sheet 111. Alternatively, a second weak portion is provided at a position of the protective sheet 119 opposite to the explosion-proof sheet 111, the second weak portion is a thickness-thinned position, and the second weak portion is configured for cracking under the impact of the molten substance discharged from the explosion-proof sheet 111 for pressure relief. By the arrangement of the protective sheet 119, when thermal runaway occurs in the cell 100, the molten substance ejected due to breaking of the explosion-proof sheet 111 may flow out after being blocked by the protective sheet 119, the impact force is greatly weakened, so that the probability of flowing to the positions of the safety valves 109 of other cells 100 is reduced, and the effect on the other cells 100 is reduced. When thermal runaway does not occur in the cell 100, the molten substance flowing out due to thermal runaway of other cells 100 also is blocked by the protective sheet 119 and be difficult to move to the explosion-proof sheet 111, and accordingly, a certain blocking effect also is provided, being able to further prevent the spreading of thermal runaway of the cells 100, and ensuring the safety of the battery module 200 and the battery pack 300.

It should be noted that, since the explosion-proof sheet 111 needs to be cracked for pressure relief, the material of the explosion-proof sheet 111 is selected to be a material having a lower strength than that of the housing 101. For example, when the material of the housing 101 is selected to be an aluminum material, the material of the explosion-proof sheet 111 is selected to be a plastic material or a metal material having a lower strength than that of the aluminum material, such as a metal sheet or a plastic sheet. Certainly, the explosion-proof sheet may also select the same material as that of the housing 101. For example, the material of both the two is selected as an aluminum material; in this case, the thickness of the explosion-proof sheet 111 is set to be slightly smaller relative to the thickness of the housing wall of the housing 101, so that the explosion-proof sheet is cracked when thermal runaway occurs in the cell 100. Moreover, a connection manner between the explosion-proof sheet 111 and the housing 101 is selected from adhesion, buckling, welding, and the like, as long as the stability after connection is ensured, which is not limited in the present embodiment.

The protective sheet 119 needs to provide protection, and thus in the present embodiment, the strength of the protective sheet 119 is selected to be relatively high, for example, the protective sheet may select the same aluminum material as the housing 101 or other metal materials with slightly higher strength, and may also select a plastic material, for example, a PET material, which may provide effective protection.

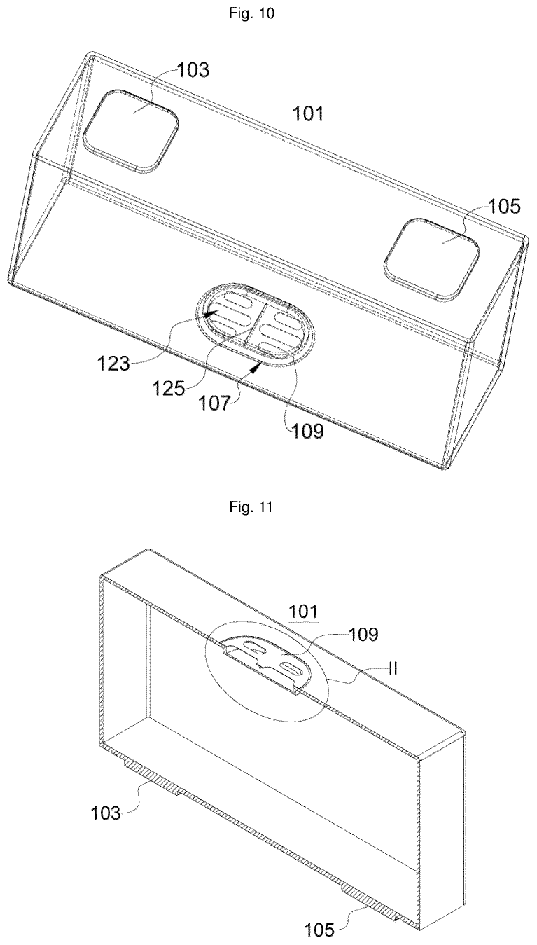

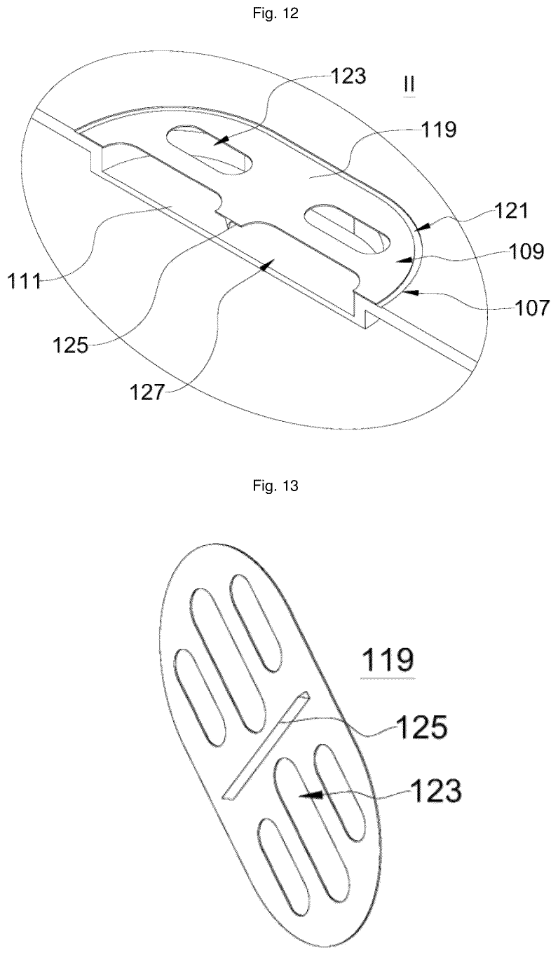

Please refer to FIGS. 10 to 12, the safety valve further includes an auxiliary cracking member, the auxiliary cracking member being formed by a sharp portion 125 provided on the protective sheet 119.

In detail, the material, structure and position of the protective sheet 119 are all the same as those of the previous embodiment, the protective sheet covers the end of the explosion-proof sheet 111 close to an explosion-proof side, and the protective sheet 119 is provided with discharge holes 123 or a first weak portion 207 to assist in pressure relief. In addition, the sharp portion 125 is located at the side of the protective sheet 119 close to the explosion-proof sheet 111, and when the explosion-proof sheet 111 moves towards the protective sheet 119 under an impact force of thermal runaway of the cell 100, the sharp portion 125 is configured to puncture the explosion-proof sheet 111.

That is, when the explosion-proof sheet 111 is subjected to an impact force in the pressure relief direction, the explosion-proof sheet 111 will move to the direction of the protective sheet 119 under the action of the impact force, and when a local part of the explosion-proof sheet 111 moves to the position of the sharp portion 125, the sharp portion 125 punctures the explosion-proof sheet 111, and at this time, the explosion-proof sheet 111 performs a pressure relief operation. The molten substance after pressure relief is discharged through the discharge holes 123, and the molten substance is blocked by the protective sheet 119 and has a weakened impact force, so that the probability of flowing to other cells 100 is reduced, thereby reducing spreading of the thermal runaway. Furthermore, by the arrangement of the protective sheet 119, the protective sheet may also block an impact force in an opposite direction of the pressure relief direction from acting on the explosion-proof sheet 111 to a certain extent, and therefore molten substance discharged when thermal runaway occurs in adjacent cells 100 or other cells 100 is blocked from reaching the explosion-proof sheet 111, reverse breaking of the explosion-proof sheet 111 is reduced, and it is ensured that the explosion-proof sheet 111 only performs unidirectional pressure relief along the pressure relief direction, thereby further slowing down or preventing spreading of the thermal runaway, and improving the safety performance of the battery module 200 and the battery pack 300.

It should be noted that, in the present embodiment, the sharp portion 125 is in an elongated strip shape, the sharp portion 125 has a triangular pyramid shape, and a tip portion thereof faces the explosion-proof sheet 111. Moreover, six discharge holes 123 are provided on the protective sheet 119, and the six discharge holes 123 are arranged in three rows and two columns; the sharp portion 125 is located at a position between the two rows of discharge holes 123, and is substantially located at the middle position of the whole protective sheet 119, so as to be directly facing the middle position of the explosion-proof sheet 111, thereby facilitating puncturing the explosion-proof sheet 111 when thermal runaway occurs in the cell 100. Of course, in other embodiments, the sharp portion 125 is in a needle-like, rod-like or other tip-like structure, and the number and arrangement manner of the discharge holes 123 is adjusted according to requirements.

In the present embodiment, the explosion-proof sheet 111 is arranged to protrude with respect to the inner surface of the housing wall of the housing 101 where the explosion-proof port 107 is provided, and the protective sheet 119 and the explosion-proof sheet 111 are spaced apart from each other to form a cavity 127 therebetween, and the outer surface of the protective sheet 119 is flush with the outer surface of the housing wall of the housing 101 where the explosion-proof port 107 is provided. On the one hand, the explosion-proof sheet 111 protruding inwards is able to allow for a cavity 127 to be formed between the explosion-proof sheet 111 and the protective sheet 119, a pressure relief space is reserved in the cavity 127, the flow speed of the molten substance after pressure relief is reduced, and the probability and risk of the molten substance flowing to other cells 100 is reduced; and on the other hand, the outer surface of the protective sheet 119 being flush with the outer surface of the housing wall is able to reduce damage to the explosion-proof sheet 111 by external debris or foreign matters, the probability of accidental damage is reduced, and the safety of the cell 100 is further improved, thereby improving the safety of the battery module 200 and the battery pack 300.

Please refer to FIG. 5 again, in the present embodiment, the battery module 200 further includes a protective plate 205. The protective plate 205 is provided with first weak portions 207, the first weak portions 207 corresponding to the safety valves 109. Each first weak portion 207 is a portion formed by thickness thinning, and the first weak portion 207 is cracked under the impact of the molten substance discharged from the safety valve 109. In this way, the protective plate 205 is located at the lower end of the whole battery module 200 and at a position close to the bottom plate 305 of the battery pack box body 301 of the battery pack 300. Accordingly, when thermal runaway occurs in the cell 100, the molten substance may break through the explosion-proof sheet 111 and the first weak portion 207 of the protective plate 205 for ejection, and at this time, the ejected molten substance is able to move towards the bottom plate 305 of the battery pack 300, and rebound back to the lower surface of the protective plate 205 after striking the bottom plate 305, thereby reducing the probability of moving to positions of the safety valves 109 of other cells 100. At this time, since the entire safety valve 109 has a one-way explosion-proof function of one-way opening, the safety valve 109 may also effectively prevent the rebounded substance from affecting other nearby cells 100.

In addition, as there is a gap between the bottom of the battery module 200 and the bottom plate 305 of the battery pack box body 301 of the battery pack 300, the chamber 311 between the battery module 200 and the bottom plate 305 of the battery pack 300 is together formed by a plurality of protective plates 205 of the plurality of battery modules 200 and the bottom plate 305 of the battery pack 300. The formation of the chamber 311 may serve as a space for storing or temporarily storing the molten substance, and may also serve as a space for buffering the molten substance, thereby further reducing the risk of the molten substance spreading to the safety valves 109 of other cells 100, and improving the safety of the battery module 200 and the battery pack 300.

Of course, in order to facilitate discharge of the molten substance in the chamber 311, a discharge port (not shown in the figure) is provided on the side frame 303 and/or the bottom plate 305 according to requirements, the discharge port is in communication with the chamber 311, and a valve is provided at the discharge port. When it is necessary to discharge the molten substance, the valve is opened; and when it is not necessary to discharge the molten substance, the valve is closed.

It should be noted that, in the present embodiment, because the protective plate 205 is located at the bottom of the battery module 200, the protective plate 205 may select a high-temperature-resistant refractory material, for example, may select high-temperature-resistant refractory materials such as metal or alloy, ceramic, or mica.

In the present embodiment, the protective plate specifically selects a mica plate to provide fire resistance and high temperature resistance performance. Moreover, the protective plate 205 is also located at the bottom of the battery module 200, and thus the protective plate 205 may also serve as a plate body for supporting the cells 100; therefore, the protective plate 205 being set to be a mica plate with a certain strength may further ensure the safety and stability of the cells 100, and further improve the safety and stability of the battery pack 300 having the battery module 200.

It should be further noted that, in the present embodiment, the two cell assemblies of each battery module 200 share one protective plate 205, however, in other embodiments, each cell of the plurality of cells 100 is correspondingly provided with one protective plate 205, and the protective plate 205 is a plate body structure covering the outside of the safety valve 109, or is a cover body structure covering the side of the cell 100 provided with the safety valve 109; and each protective plate 205 has a first weak portion 207, the first weak portion 207 is cracked by the impact of the molten substance discharged from the corresponding safety valve 109, which are all not limited in the present embodiment.

Embodiments of the present disclosure further provide an electric device, including an electric mechanism, and the described cells 100, battery modules 200 or battery pack 300. The electric mechanism is selected as mechanisms of a vehicle, a ship, a spacecraft, or the like. The electric mechanism may supply power by the described cells 100, battery pack 300, or battery modules 200. Accordingly, the electric mechanism also has the advantage of high safety performance.

Hereinafter, by taking the structure as shown in FIG. 1 to FIG. 8 as an example, the mounting technological process, working principle and beneficial effects of the battery pack 300 provided in embodiment of the present disclosure will be described in detail:

When the battery pack 300 is performing assembling operation, it is only necessary to support an assembled battery module 200 on the bottom plate 305 of the battery pack box body 301 of the battery pack 300. During the assembling operation of the battery module 200, the end plates 202 and the side plates 203 are first assembled to form the outer housing 201, and a plurality of assembled cells 100 are stacked in the outer housing 201. Moreover, when assembling the cell 100, the positive electrode terminal 103 and the negative electrode terminal 105 is provided on one side of the housing 101 of the cell 100, the explosion-proof port 107 is provided on the other side of the housing 101 of the cell 100, and the winding core is provided in the housing 101 of the cell 100; and a positive electrode lug of the winding core is electrically connected to the positive electrode terminal 103, and a negative electrode lug of the winding core is electrically connected to the negative electrode terminal 105, and the safety valve 109 is provided at the explosion-proof port 107, so that the groove opening 117 of the groove 113 of the explosion-proof sheet 111 faces away from the positive electrode terminal 103 and the negative electrode terminal 105 and faces the protective sheet 119, so that the outer surface of the protective sheet 119 is flush with the outer surface of the housing wall of the housing 101.

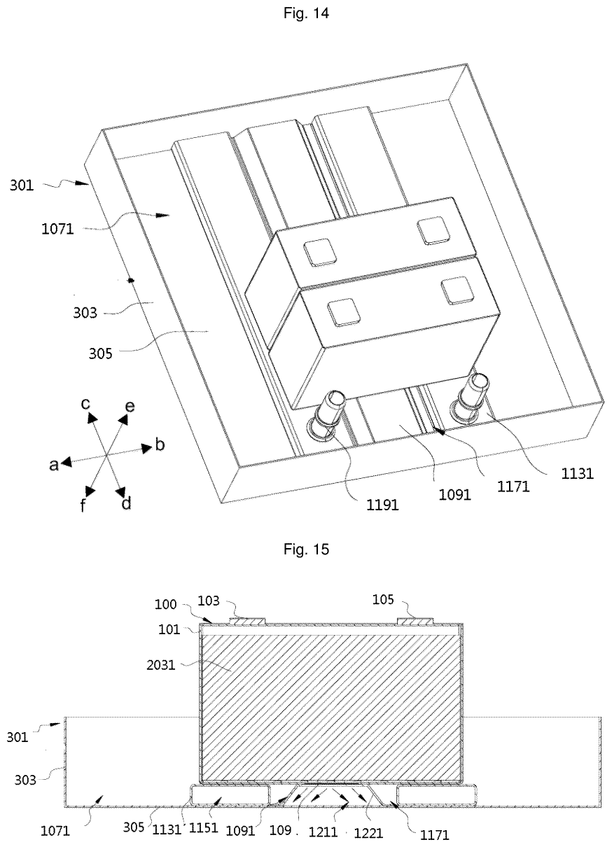

In the embodiments shown in FIGS. 14 to 18, the cooling mechanism and an accommodation pipeline are further described in detail.

After thermal runaway occurs in a single cell 100, molten substance thereof will be ejected into the accommodation space 1071 of the battery pack box body 301, and therefore an accommodation pipeline 1091 is further provided on the bottom plate 305 of the battery pack box body 301, and the accommodation pipeline 1091 extends along the second direction (consistent with the stacking direction of the cells 100 in the battery module) and is provided in the accommodation space 1071. Furthermore, the side of the accommodation pipeline 1091 away from the bottom plate 305 is provided with accommodation holes 1111, the accommodation holes 1111 correspond to the safety valves 109 and are configured for bearing the molten substance ejected when thermal runaway occurs in the cell 100 in the accommodation space 1071, and the accommodation pipeline 1091 is configured for accommodating the molten substance collected by the accommodation holes 1111. As the accommodation holes 1111 of the accommodation pipeline 1091 are arranged facing upwards, the molten substance ejected from the cell 100 is able to move to the accommodation pipeline 1091 under the action of gravity, so as to be accommodated by the accommodation holes 1111 of the accommodation pipeline 1091, thereby reducing the splashing of the molten substance, and further reducing the effect on other cells 100 in which thermal runaway does not occur, and then the problem of thermal runaway spreading is alleviated, and the safety performance is improved.

Furthermore, the bottom plate 305 is further provided with a cooling mechanism extending in the second direction, the cooling mechanism is also located in the accommodation space 1071 and is generally rectangular, and the cooling mechanism accommodates a cooling liquid or cooling water therein for cooling the cells 100 in the accommodation space 1071. On the one hand, by the arrangement of the cooling mechanism, the cells 100 is cooled to reduce the risk of thermal runaway of the cells 100, so as to improve the safety of the battery pack; on the other hand, the mounting space of the bottom plate 305 is fully utilized, so that the space utilization of the battery pack is fully improved, thereby making the structure of the battery pack more compact and reliable.

It should be noted that, in the present embodiment, the number of the accommodation pipelines 1091 is set to match the number of the battery modules, so that one accommodation pipeline 1091 is correspondingly provided regarding every multiple cells 100 stacked in the second direction.

In the present embodiment, the cooling mechanism at least includes two cooling pipelines 1131 located at two sides of the accommodation pipeline 1091, a mounting groove 1171 is formed between the two cooling pipelines 1131, and the accommodation pipeline 1091 is mounted in the mounting groove 1171. Such an arrangement may make full use of the mounting space of the bottom plate 305, to fully improve the space utilization of the battery pack.

The two cooling pipelines 1131 are both in a rectangular strip shape, and a rectangular cooling cavity 1151 is formed inside each cooling pipeline, so that the cells 100 are sufficiently cooled, and the cooling effect is ensured, thereby improving the safety of the cells 100.

Certainly, in other embodiments, the battery pack box body 301 is configured to include a plurality of accommodation pipelines 1091 arranged at intervals, the cooling mechanism includes a plurality of cooling pipelines 1131 arranged at intervals, and the plurality of cooling pipelines 1131 and the plurality of accommodation pipelines 1091 are alternately arranged in sequence, so as to fully improve the accommodation effect and the cooling effect.

In the embodiment shown in FIG. 18, the heights of the cooling pipelines 1131 and the accommodation pipeline 1091 protruding relative to the bottom plate 305 is set to be the same, so that the cells 100 is directly supported by the cooling pipelines 1131 and the accommodation pipeline 1091 together. Such an arrangement may make full use of the space inside the battery pack box body 301, thereby ensuring the stability of the cells 100 and ensuring the compactness and reliability of the battery pack structure.

In addition, each cooling pipeline 1131 is provided with a first connector 1191, and the respective first connectors 1191 of the two cooling pipelines 1131 are led out through one pipeline respectively, that is, in a series connection state. Certainly, in other embodiments, two first connectors 1191 of the two cooling pipelines 1131 is connected and then led out through a pipeline, that is, in a parallel connection state. Moreover, a second connector is provided on the accommodation pipeline 1091, and the second connector is led out through one pipeline, so as to facilitate discharge of the accommodated molten substance, thereby further improving the safety.

In the present embodiment, the number of the accommodation holes 1111 on each accommodation pipeline 1091 matches the number of the safety valves 109 of the cells 100 in each battery module, so that the plurality of safety valves 109 correspond to the plurality of accommodation holes 1111 in a one-to-one manner, so that the molten substance ejected from each safety valve 109 is accommodated by a corresponding accommodation hole of the plurality of accommodation holes 1111, which may reduce random flowing of the molten substance to other places, thereby further improving the safety of the battery pack.

In order to ensure the accommodation effect, the size of each accommodation hole 1111 is set to be slightly larger than the size of the corresponding safety valve 109, so that the projection of the safety valve 109 in a vertical direction (i.e. the of direction in FIG. 14) completely falls within the range of the corresponding accommodation hole of the plurality of accommodation holes 1111. It should be further noted that, in the present embodiment, the safety valve 109 is configured to protrude relative to the surface of the cell 100, so as to extend into the corresponding accommodation hole of the plurality of accommodation holes 1111, so as to fully ensure the accommodation effect. When the safety valve 109 extends into the corresponding accommodation hole of the plurality of accommodation holes 1111, the end face of the cell 100 is supported by the upper surfaces of the accommodation pipeline 1091 and the cooling pipelines 1131. In this case, the end face of the cell 100 is able to close the corresponding accommodation hole of the plurality of accommodation holes 1111. With such an arrangement, on the one hand, the stability and safety of the cell 100 is improved, so as to improve the stability, reliability and safety of the battery pack. On the other hand, each accommodation hole 1111 also is closed when thermal runaway does not occur in the cell 100, thereby further preventing external moisture from entering the interior of the battery pack through the accommodation hole 1111, and ensuring the service life and use performance of the battery pack.

In another embodiment, the safety valve 109 is recessed in the end face (the second surface) of the cell 100, and in this case, the end of the cell 100 provided with the safety valve 109 is substantially of a bowl-shaped structure, and the safety valve 109 is located at a bowl bottom of the bowl-shaped structure, so that the circumference of the end of the cell 100 provided with the safety valve 109 is supported on the upper surfaces of the accommodation pipeline 1091 and the cooling pipelines 1131; and after the cell 100 is stably supported by the accommodation pipeline 1091, the safety valve 109 and the accommodation hole 1111 are arranged at an interval in the vertical direction, and the end face of the cell 100 provided with the safety valve 109 closes the corresponding accommodation hole of the plurality of accommodation holes 1111. With such an arrangement, the stability and safety of the cell 100 is able to also be improved, so as to improve the stability, reliability and safety of the battery pack. Moreover, each accommodation hole 1111 also is closed when thermal runaway does not occur in the cell 100, thereby further preventing external moisture from entering the interior of the battery pack through the accommodation hole 1111, and ensuring the service life and use performance of the battery pack.

Please refer to FIGS. 14 to 17, in the present embodiment, the accommodation pipeline 1091 includes an accommodation plate 1221 arranged in a bent manner, the accommodation holes 1111 are provided on the accommodation plate 1221, the accommodation plate 1221 has a bottom opening 1211, the accommodation plate 1221 is arranged on the bottom plate 305, the bottom opening 1211 is closed by the bottom plate 305, and the accommodation plate 1221 and the bottom plate 305 together enclose a channel for accommodating molten substance. By configuring the accommodation pipeline 1091 as an accommodation plate 1221 having a bottom opening 1211, on the one hand, the structure of the bottom plate 305 is configured to form an accommodation pipeline, thereby saving costs and simplifying the mounting process.

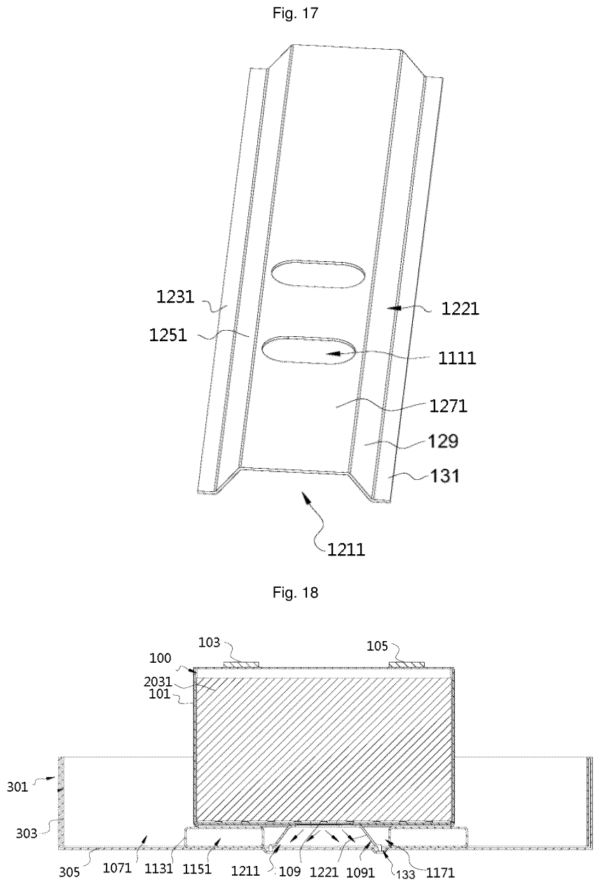

Refer to FIG. 17 again, in the present embodiment, the accommodation plate 1221 is substantially “ [symbol] ”-shaped, and the accommodation plate 1221 specifically includes a first plate 1231, a second plate 1251, a third plate 1271, a fourth plate 129 and a fifth plate 131, which are connected at an angle in sequence. The first plate 1231 and the fifth plate 131 are located at two ends, and are configured to be parallel to the bottom plate 305, or are configured to form an angle with the bottom plate 305, for example, perpendicular to the bottom plate. The third plate 1271 and the bottom plate 305 are parallel to each other and arranged at an interval, the accommodation holes 1111 are provided on the third plate 1271, the second plate 1251 is obliquely connected between the first plate 1231 and the third plate 1271, and the fourth plate 129 is obliquely connected between the third plate 1271 and the fifth plate 131. On the one hand, by configuring that the third plate 1271 and the bottom plate 305 are parallel to each other and arranged at an interval, it can be ensured that the third plate may stably support the cell 100 together with the cooling pipeline 1131; on the other hand, the second plate 1251 and the fourth plate 129 are both obliquely arranged, so that the cross section of the accommodation pipeline 1091 has a trapezoid structure, and the accommodation pipeline 1091 has a large space and has a good accommodation effect, and may perform drainage and guiding by the second plate 1251 and the fourth plate 129, thereby ensuring that the collected molten substance may flow along the extension directions of the second plate 1251 and the fourth plate 129, further ensuring the accommodation effect.

In the present embodiment, the angle between the second plate 1251 and the third plate 1271 and the angle between the fourth plate 129 and the third plate 1271 are both greater than 90°, for example, both of them are set to 120°, so that the space size of the accommodation pipeline 1091 is fully ensured, while the drainage and guiding effects are fully ensured. Certainly, in other embodiments, the angles are adjusted according to requirements.

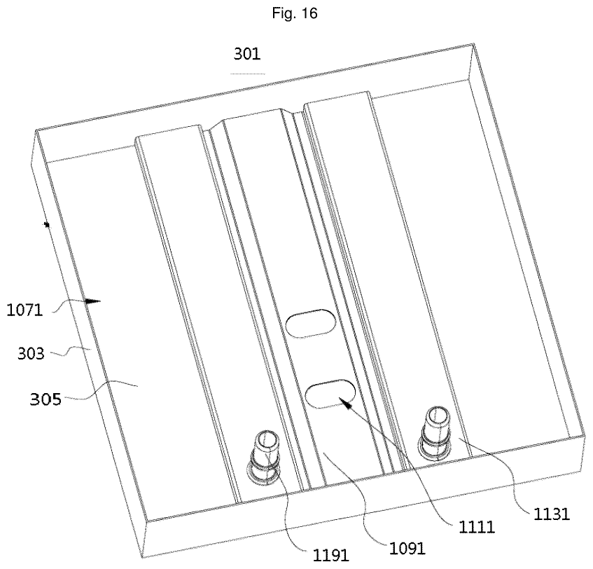

Please refer to FIGS. 15 and 17 again, in the present embodiment, the first plate 1231 and the fifth plate 131 of the accommodation pipeline 1091 are both parallel to the bottom plate 305; in this case, a matching manner between the accommodation pipeline 1091 and the bottom plate 305 is selected as welding, and the surfaces of the first plate 1231 and the fifth plate 131 attached to the bottom plate 305 serve as a welding surface, so as to fully ensure the welding effect. Certainly, in the present embodiment, the connection manner between the accommodation pipeline 1091 and the bottom plate 305 is a detachable manner, such as adhesion, buckling, snap-fit, etc., or an integrally formed fastening manner.

In FIG. 18, when the accommodation pipeline 1091 is adhered to the bottom plate 305, the first plate 1231 and the fifth plate 131 are set to be perpendicular to the bottom plate 305; in this case, the bottom plate 305 has two bottom plate grooves 133 recessed in a direction away from the accommodation holes 1111, an adhesive is accommodated in both the two bottom plate grooves 133, and the first plate 1231 and the fifth plate 131 are able to respectively extend into the two bottom plate grooves 133 so as to be connected to the adhesive in the bottom plate grooves 133. By the arrangement of the bottom plate grooves 133, on the one hand, more adhesive is accommodated, and the stability and reliability after the bottom plate grooves are connected to the first plate 1231 or the fifth plate 131 are ensured; and on the other hand, the sealing effect is improved, so that the probability of situations such as air leakage and liquid leakage is reduced, thereby further improving the safety of the battery pack. Of course, when performing connection in an adhesion manner, the first plate 1231 and the fifth plate 131 are configured to be parallel to the bottom plate 305; in this case, the lower surfaces of the first plate 1231 and the fifth plate 131 respectively seal the corresponding bottom plate grooves 133, and are connected to the adhesive in the corresponding bottom plate grooves 133, so as to fully ensure the sealing performance and the connection strength.

In the present embodiment, when the accommodation pipeline 1091 is welded to the bottom plate 305, the accommodation pipeline 1091 and the bottom plate 305 may select the same high-melting-point metal. When the accommodation pipeline 1091 is adhered to the bottom plate 305, the accommodation pipeline 1091 may select a different high-melting-point metal from the bottom plate 305. When the battery pack is mounted, the accommodation pipeline 1091 is first welded to the bottom plate 305 to form a channel, and then the two cooling pipelines 1131 are respectively provided on the bottom plate 305 and respectively located at two sides of the accommodation pipeline 1091; then, a plurality of cells 100 are stacked in the battery pack box body 301, the safety valves 109 of the cells 100 are aligned with the accommodation holes 1111 of the accommodation pipeline 1091, and the cells 100 are stably supported by the cooling pipelines 1131 and the accommodation pipeline 1091 together.

The content above merely relates to preferred embodiments of the present disclosure and is not intended to limit some embodiments of the present disclosure. For a person skilled in the art, some embodiments of the present disclosure may have various modifications and variations. Any modifications, equivalent replacements, improvements, etc. made within the spirit and principle of some embodiments of the present disclosure shall all belong to the scope of protection of some embodiments of the present disclosure.

What is claimed is:

1. A battery pack, comprising a battery pack box body and a plurality of cells, wherein the battery pack box body has an accommodation space, the plurality of cells are stacked in the accommodation space, and each cell of the plurality of cells has a safety valve, a positive electrode terminal and a negative electrode terminal, the positive electrode terminal and the negative electrode terminal are located on a first surface of the cell, and the safety valve is located on a second surface of the cell, the first surface and the second surface are a group of opposite surfaces of the cell;
the battery pack box body further comprises an accommodation pipeline and a cooling mechanism, wherein
the accommodation pipeline and the cooling mechanism are both located in the accommodation space, and the second surface is arranged to face the accommodation pipeline and the cooling mechanism, the cooling mechanism is configured for supporting the second surface and cooling the cell, accommodation holes of the accommodation pipeline are arranged corresponding to the safety valves, and the accommodation pipeline is configured for accommodating molten substance collected by the accommodation holes.

2. The battery pack according to claim 1, wherein
the accommodation pipeline is provided with a plurality of accommodation holes of which the number matches the number of the plurality of cells, and a plurality of safety valves are arranged in one-to-one correspondence with the plurality of accommodation holes; or
each of the safety valves is able to extend into a corresponding accommodation hole of the plurality of accommodation holes.

3. The battery pack according to claim 1, wherein
the safety valve is recessed in the second surface of the cell, the safety valve and the accommodation hole are opposite to each other and are arranged at an interval, and the circumference of the second surface is supported on the accommodation pipeline and closes a corresponding accommodation hole of the plurality of accommodation holes.

4. The battery pack according to claim 1, wherein
the cooling mechanism at least comprises two cooling pipelines located at two sides of the accommodation pipeline, a mounting groove is formed between the two cooling pipelines, and the accommodation pipeline is mounted in the mounting groove; or,
the battery pack box body comprises a plurality of accommodation pipelines arranged at intervals, the cooling mechanism comprises a plurality of cooling pipelines arranged at intervals, and the plurality of cooling pipelines and the plurality of accommodation pipelines are alternately arranged in sequence.

5. The battery pack according to claim 1, wherein the battery pack box body further comprises a bottom plate, the accommodation pipeline and cooling pipelines of the cooling mechanism are both arranged on the bottom plate, and the second surface of the cell is arranged to face the bottom plate, the accommodation pipeline comprises an accommodation plate arranged in a bent manner; the accommodation holes are provided on the accommodation plate, the accommodation plate has a bottom opening, the accommodation plate is arranged on the bottom plate, the bottom opening is closed by the bottom plate, and the accommodation plate and the bottom plate together enclose a channel for accommodating molten substance.

6. The battery pack according to claim 5, wherein the bottom plate has a bottom plate groove recessed in a direction away from the accommodation holes, the bottom plate groove is configured for accommodation an adhesive, and an end edge of the accommodation plate provided with the opening extends into the bottom plate groove so as to be connected to the adhesive.

7. The battery pack according to claim 5, wherein
the accommodation pipeline is welded to the bottom plate; or,
the accommodation pipeline and the bottom plate are integrally formed.

8. The battery pack according to claim 1, wherein the safety valve is provided at the middle position of the second surface.

9. The battery pack according to claim 1, wherein the battery pack further comprises a protective plate, the protective plate comprises a first weak portion, and the first weak portion is arranged corresponding to the safety valve, so that the first weak portion is cracked under the impact of the molten substance discharged from the safety valve.

10. The battery pack according to claim 1, wherein the cell is provided with an explosion-proof port, the safety valve is provided at the explosion-proof port, and the safety valve comprises:
an explosion-proof sheet, the explosion-proof sheet being recessed into an inner side of the cell in a direction opposite to a pressure relief direction; and
a protective sheet, the protective sheet being spaced apart from the explosion-proof sheet to form a cavity therebetween, and the protective sheet covering an outer side of the explosion-proof sheet.

11. The battery pack according to claim 10, wherein
the protective sheet is provided with one or more discharge holes, and the discharge holes are configured for discharging the molten substance discharged from the explosion-proof sheet; or,
the protective sheet is provided with a second weak portion, and the second weak portion is configured for cracking under the impact of the molten substance discharged from the explosion-proof sheet for pressure relief.

12. The battery pack according to claim 11, wherein the explosion-proof sheet is provided with a groove, and an opening of the groove faces towards the protective sheet.

13. The battery pack according to claim 12, wherein a perpendicular distance from a groove opening of the groove to the bottom of the groove is the depth of the groove, and the depth of the groove is smaller than the thickness of the explosion-proof sheet in the pressure relief direction.

14. The battery pack according to claim 13, wherein the safety valve further comprises an auxiliary cracking member,
the auxiliary cracking member comprises a sharp portion provided on the protective sheet, the sharp portion is located at the side of the protective sheet close to the explosion-proof sheet, and when the explosion-proof sheet moves towards the protective sheet under an impact force of thermal runaway of the cell, the sharp portion is configured to puncture the explosion-proof sheet.

15. The battery pack according to claim 10, wherein an outer surface of the protective sheet is flush with the second surface.

16. The battery pack according to claim 1, wherein the plurality of cells form a battery module, the battery module further comprises two end plates, and the plurality of cells are stacked between the two end plates in a preset direction.

17. The battery pack according to claim 16, wherein the battery pack box body further comprises a side frame and a bottom plate, the side frame is provided with a supporting step, the battery module is supported on the supporting step, and the bottom of the battery module is spaced apart from the bottom plate and a chamber is formed therebetween.

18. The battery pack according to claim 17, wherein
a discharge port is provided on the side frame and/or the bottom plate, and the discharge port is in communication with the chamber.
